(19) United States
(12) Patent Application Publication
(10) Pub. No.: US 2024/0169154 A1
(43) Pub. Date: May 23, 2024

(54) INFORMATION PROCESSING DEVICE, INFORMATION PROCESSING METHOD, AND RECORDING MEDIUM

(71) Applicant: NEC Corporation, Tokyo (JP)

(72) Inventor: Kunihiro Takeoka, Tokyo (JP)

(73) Assignee: NEC Corporation, Tokyo (JP)

(21) Appl. No.: 18/279,273

(22) PCT Filed: Mar. 5, 2021
(86) PCT No.: PCT/JP2021/008743

§ 371 Date: Aug. 29, 2023

(51) Int. Cl. G06F 40/289; G06F 40/40

(52) U.S. Cl. CPC G06F 40/289; G06F 40/40

(57) ABSTRACT

In order to generate a desired taxonomy more accurately, an information processing apparatus (1) includes: an obtaining section (11) that obtains a sentence group and auxiliary information which relates to a taxonomy to be constructed; a generating section (12) that generates a phrase with reference to the sentence group; and a constructing section (13) that constructs the taxonomy by estimating a relationship between a plurality of phrases including the phrase. One or both of the generating section (12) and the constructing section (13) use the auxiliary information.

### TECHNICAL FIELD

The present invention relates to a technique of generating a taxonomy.

### BACKGROUND ART

A technique of generating a taxonomy is known. A taxonomy is information indicating a relationship between a plurality of phrases, and is represented by a directed graph having a hierarchy.

Non-Patent Literature 1, for example, discloses a technique of constructing a probabilistic taxonomy. In the technique, phrases are extracted from a sentence group, a probability value is given to a relationship between the extracted phrases, and a graph between the phrases which graph has been constructed on the basis of the probability value is converted into a taxonomy.

Non-Patent Literature 2, for example, discloses a technique of generating a taxonomy by adding, to a seed taxonomy, a phrase extracted from a sentence group. The seed taxonomy is an incomplete and relatively small taxonomy which has been generated manually, for example.

### CITATION LIST

### Non-Patent Literature

[Non-patent Literature 1]
Wentao Wu et al., “Probase: A Probabilistic Taxonomy for Text Understanding”, SIGMOD 2012
[Non-patent Literature 2]
Jiaming Shen et al., “HiExpan: Task-Guided Taxonomy Construction by Hierarchical Tree Expansion”, KDD 2018.

### SUMMARY OF INVENTION

### Technical Problem

However, in the techniques disclosed in Non-Patent Literatures 1 and 2, there is a possibility that a phrase which does not conform to a purpose of a taxonomy is extracted from a sentence group. Moreover, in these techniques, there is a possibility that a relationship which does not conform to a purpose of a taxonomy is estimated as a relationship between phrases. Therefore, these techniques have room for improvement in terms of accurately generating a desired taxonomy which conforms to a purpose.

An example aspect of the present invention has been made in view of the above problems, and an example object thereof is to provide a technique of generating a desired taxonomy more accurately.

### Solution to Problem

An information processing apparatus in accordance with an example aspect of the present invention is an information processing apparatus including: an obtaining means for obtaining a sentence group and auxiliary information which relates to a taxonomy to be constructed; a generating means for generating a phrase with reference to the sentence group; and a constructing means for constructing the taxonomy by estimating a relationship between a plurality of phrases including the phrase, one or both of the generating means and the constructing means using the auxiliary information.

An information processing method in accordance with an example aspect of the present invention is an information processing method including: obtaining a sentence group and auxiliary information which relates to a taxonomy to be constructed; generating a phrase with reference to the sentence group; and constructing the taxonomy by estimating a relationship between a plurality of phrases including the phrase, in one or both of generating the phrase and constructing the taxonomy, the auxiliary information being used.

A program in accordance with an example aspect of the present invention is a program for causing a computer to function as an information processing apparatus, the program causing the computer to function as: an obtaining means for obtaining a sentence group and auxiliary information which relates to a taxonomy to be constructed; a generating means for generating a phrase with reference to the sentence group; and a constructing means for constructing the taxonomy by estimating a relationship between a plurality of phrases including the phrase, one or both of the generating means and the constructing means using the auxiliary information.

### Advantageous Effects of Invention

According to an example aspect of the present invention, it is possible to generate a desired taxonomy more accurately.

### BRIEF DESCRIPTION OF DRAWINGS

FIG. 1 is a block diagram illustrating a configuration of an information processing apparatus in accordance with a first example embodiment.

FIG. 2 is a flowchart illustrating a flow of an information processing method in accordance with the first example embodiment.

FIG. 3 is a block diagram illustrating a configuration of an information processing apparatus in accordance with a second example embodiment.

FIG. 4 is a flowchart illustrating a flow of an information processing method in accordance with the second example embodiment.

FIG. 5 is a flowchart illustrating an example of a detailed flow of a process of generating phrases in the second example embodiment.

FIG. 6 is a flowchart illustrating an example of a detailed flow of a process of estimating a relationship in the second example embodiment.

FIG. 7 is a block diagram illustrating a configuration of an information processing apparatus in accordance with a third example embodiment.

FIG. 8 is a drawing schematically illustrating an example of a taxonomy obtained in the third example embodiment.

FIG. 9 is a flowchart illustrating a flow of an information processing method in accordance with the third example embodiment.

FIG. 10 is a flowchart illustrating an example of a detailed flow of a process of generating a phrase in the third example embodiment.

FIG. 11 is a flowchart illustrating an example of a detailed flow of a process of estimating a relationship in the second example embodiment.

FIG. 12 is a block diagram illustrating an example hardware configuration of each of the information processing apparatuses in accordance with the example embodiments of the present invention.

### DESCRIPTION OF EMBODIMENTS

### First Example Embodiment

The following description will discuss, in detail, a first example embodiment of the present invention with reference to drawings. The present example embodiment is made the basis of example embodiments described later.

<Configuration of information processing apparatus 1>

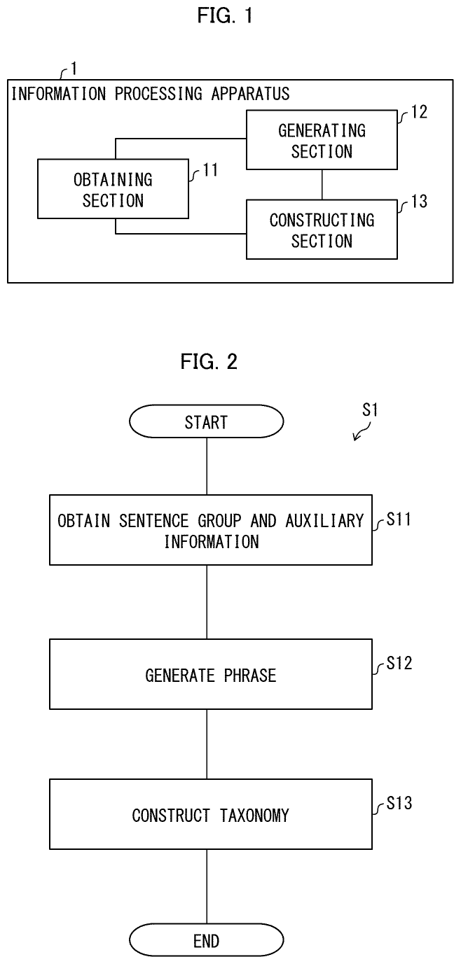

A configuration of an information processing apparatus 1 in accordance with the present example embodiment is described with reference to FIG. 1. FIG. 1 is a block diagram illustrating a functional configuration of the information processing apparatus 1.

As illustrated in FIG. 1, the information processing apparatus 1 includes an obtaining section 11, a generating section 12, and a constructing section 13. The obtaining section 11 is an example of a configuration that realizes an obtaining means recited in the claims. The generating section 12 is an example of a configuration that realizes a generating means recited in the claims. The constructing section 13 is an example of a configuration that realizes a constructing means recited in the claims.

The obtaining section 11 obtains a sentence group and auxiliary information which relates to a taxonomy to be constructed. The generating section 12 generates a phrase with reference to the sentence group. The constructing section 13 constructs the taxonomy by estimating a relationship between a plurality of phrases including the phrase generated by the generating section 12. One or both of the generating section 12 and the constructing section 13 use the auxiliary information.

(Phrase)

A phrase is expressed by one or more words, and expresses a concept. For example, a phrase “pasta” expresses a concept of a kneaded product which mainly contains wheat flour and which is one of staple diets in Italian cuisine. The phrase “Italian cuisine” expresses a concept of cuisine originating from Italy. In the following description, a “concept expressed by a phrase” is referred to simply as “phrase”. Therefore, an expression “a relationship exists between concepts expressed by respective two phrases” is referred to as “a relationship exists between two phrases”. For example, the phrase “pasta” is included in the phrase “Italian cuisine”. Therefore, a parent-child relationship exists between these phrases.

(Taxonomy)

A taxonomy is information indicating a relationship between a plurality of phrases. For example, the taxonomy is represented by a directed graph having a hierarchy. Specifically, the taxonomy includes (i) information indicating a node which indicates each phrase and (ii) information indicating an edge which connects two nodes having a parent-child relationship therebetween. A taxonomy to be constructed is a taxonomy outputted by the information processing apparatus 1.

Note that a hierarchy in a taxonomy defines a parent-child relationship between phrases having a relationship therebetween. For example, the parent-child relationship may indicate a relationship in which a parent is a superordinate concept and a child is a subordinate concept. Alternatively, the parent-child relationship may indicate, for example, a relationship in which a parent is an organization and a child is a member belonging to the organization. Alternatively, the parent-child relationship may indicate, for example, a geographical inclusion relationship.

Parent-child relationships included in the same taxonomy can differ depending on hierarchy levels. For example, in a taxonomy relating to soccer teams, a parent-child relationship between the first hierarchy level and the second hierarchy level may indicate a geographical inclusion relationship (a parent is a country or a region and a child is a soccer team), and a parent-child relationship between the second hierarchy level and the third hierarchy level may indicate an organization-member relationship (a parent is a soccer team and a child is a player).

(Sentence Group)

A sentence group is a group of sentences. The sentence group is referred to when a phrase to be included in a taxonomy to be constructed is generated.

(Auxiliary Information)

Auxiliary information is information relating to a taxonomy to be constructed. The auxiliary information may include a natural language sentence. Further, the auxiliary information may include a group of words.

For example, the auxiliary information may include information which indicates a purpose of the taxonomy to be constructed. The purpose of the taxonomy may be, for example, an intention to generate the taxonomy or an application of the taxonomy. The auxiliary information may include information which limits a phrase to be included in the taxonomy to be constructed. The auxiliary information may include information which indicates a relationship between phrases in the taxonomy to be constructed.

Examples of the auxiliary information that includes information which limits a phrase include auxiliary information that includes a natural language sentence such as “taxonomy of food materials appearing in recipes” or “taxonomy about cooking actions appearing in recipes”.

Examples of the auxiliary information that includes information which indicates a relationship include auxiliary information that includes a natural language sentence such as “taxonomy which relates to soccer teams and in which the soccer teams are classified by countries or regions” or “taxonomy which relates to soccer teams and which includes up to players currently belonging to the soccer teams”.

<Flow of Information Processing Method S1>

A flow of an information processing method S1 carried out by the information processing apparatus 1 configured as described above is described with reference to FIG. 2. FIG. 2 is a flowchart illustrating the flow of the information processing method S1. As illustrated in FIG. 2, the information processing method S1 includes steps S11 to S13.

(Step S11)

In the step S11, the obtaining section 11 obtains a sentence group and auxiliary information. For example, the obtaining section 11 may obtain one or both of the sentence group and the auxiliary information from a memory (not illustrated) of the information processing apparatus 1, from another apparatus which is connected to the information processing apparatus 1 via a network, or via an input apparatus.

(Step S12)

In the step S12, the generating section 12 generates a phrase with reference to the sentence group. Note that “generating a phrase with reference to the sentence group” may be “extracting a phrase included in the sentence group” or may be “predicting a phrase which is not necessarily included in the sentence group, on the basis of the sentence group”. In this step, the generating section 12 may or may not use the auxiliary information so as to generate the phrase with reference to the sentence group. Note, however, that, in at least one of the steps S12 and S13, which is described later, the auxiliary information is used.

(Case where Auxiliary Information is Used)

For example, the generating section 12 generates, with reference to the sentence group, the phrase which is similar to the auxiliary information. Specifically, the generating section 12 calculates a degree of similarity between the auxiliary information and the phrase which has been generated with reference to the sentence group. In a case where the calculated degree of similarity satisfies a given condition, the generating section 12 employs the phrase as a phrase to be included in a taxonomy to be constructed. In a case where the calculated degree of similarity does not satisfy the given condition, the generating section 12 does not employ the phrase.

(Case where Auxiliary Information is not Used)

For example, the generating section 12 generates the phrase with reference to the sentence group, and sets the generated phrase as a phrase to be included in the taxonomy to be constructed.

(Step S13)

In the step S13, the constructing section 13 constructs the taxonomy by estimating a relationship between a plurality of phrases including the phrase generated in the step S12. In this step, the constructing section 13 may or may not use the auxiliary information so as to estimate the relationship between the plurality of phrases. Note, however, that, as described above, in at least one of the steps S12 and S13, the auxiliary information is used.

(Case where Auxiliary Information is Used)

For example, the constructing section 13 estimates a relationship which conforms to the auxiliary information, as the relationship between the plurality of phrases. Specifically, the constructing section 13 calculates information indicating the relationship between the plurality of phrases, and corrects the calculated information with use of the auxiliary information. The constructing section 13 constructs the taxonomy by associating the plurality of phrases on the basis of the corrected information.

(Case where Auxiliary Information is not Used)

For example, the constructing section 13 calculates information indicating the relationship between the plurality of phrases, and constructs the taxonomy by associating the plurality of phrases on the basis of the calculated information.

### Effects of the Present Example Embodiment

As described above, the information processing apparatus 1 in accordance with the present example embodiment uses auxiliary information in one or both of (i) a generating process of generating a phrase with reference to a sentence group and (ii) a process of constructing a taxonomy by estimating a relationship between a plurality of phrases including the generated phrase. Thus, in a case where the auxiliary information is used in the generating process, there is a high possibility that phrases included in the constructed taxonomy conform to contents of the auxiliary information. In a case where the auxiliary information is used in the constructing process, there is a high possibility that a relationship between a plurality of phrases in the constructed taxonomy conforms to the contents of the auxiliary information. The auxiliary information is information relating to the taxonomy to be constructed. Therefore, in the present example embodiment, it is possible to construct a desired taxonomy more accurately.

### Second Example Embodiment

The following description will discuss, in detail, a second example embodiment of the present invention with reference to drawings. Note that elements having the same functions as those of the elements described in the first example embodiment are denoted by the same reference signs, and descriptions thereof will be omitted as appropriate.

<Configuration of Information Processing Apparatus 2>

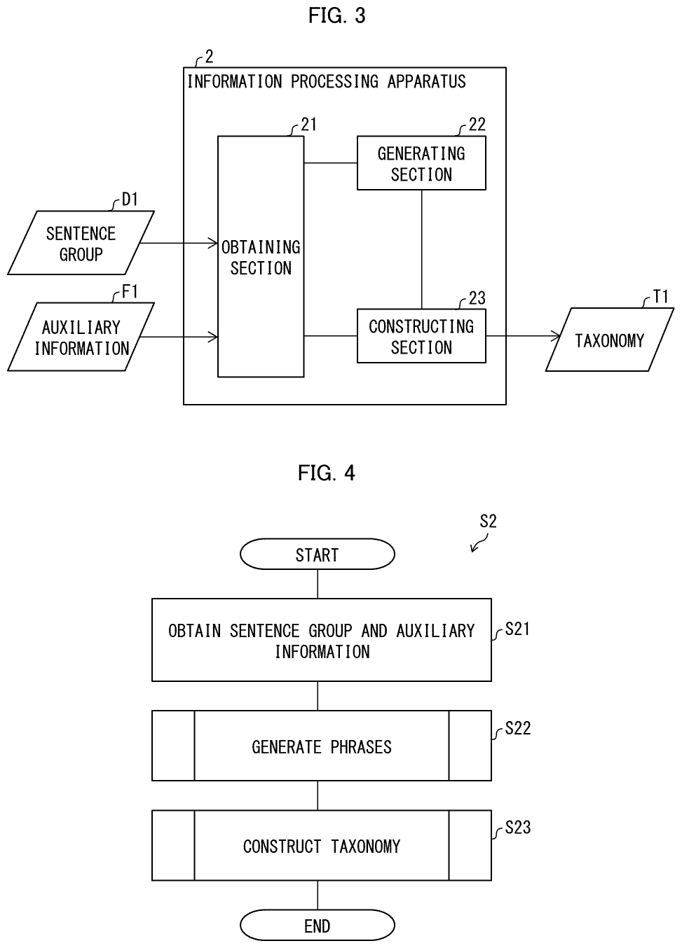

A configuration of an information processing apparatus 2 in accordance with the present example embodiment is described with reference to FIG. 3. FIG. 3 is a block diagram illustrating a functional configuration of the information processing apparatus 2. As illustrated in FIG. 3, the information processing apparatus 2 is an apparatus into which a sentence group D1 and auxiliary information F1 are inputted and which outputs a taxonomy T1. The information processing apparatus 2 includes an obtaining section 21, a generating section 22, and a constructing section 23. The obtaining section 21 is configured similarly to the obtaining section 11 in the first example embodiment. The generating section 22 generates a plurality of phrases which are similar to the auxiliary information F1, with reference to the sentence group D1. The constructing section 23 estimates a relationship which conforms to the auxiliary information F1, as a relationship between the plurality of phrases.

<Flow of Information Processing Method S2>

A flow of an information processing method S2 carried out by the information processing apparatus 2 configured as described above is described with reference to FIG. 4. FIG. 4 is a flowchart illustrating the flow of the information processing method S2. As illustrated in FIG. 4, the information processing method S2 includes steps S21 to S23.

(Step S21)

In the step S21, the obtaining section 21 obtains a sentence group D1 and auxiliary information F1. Details of this step are as described in connection with the step S11 in the first example embodiment.

(Step S22)

In the step S22, the generating section 22 generates phrases which are similar to the auxiliary information F1, with reference to the sentence group D1. Details of this step are described later.

(Step S23)

In the step S23, the constructing section 23 estimates a relationship which conforms to the auxiliary information F1, as a relationship between the plurality of phrases to be included in a taxonomy T1. The constructing section 23 constructs the taxonomy T1 with reference to an estimation result. Details of this step are described later.

<Details of Step S22>

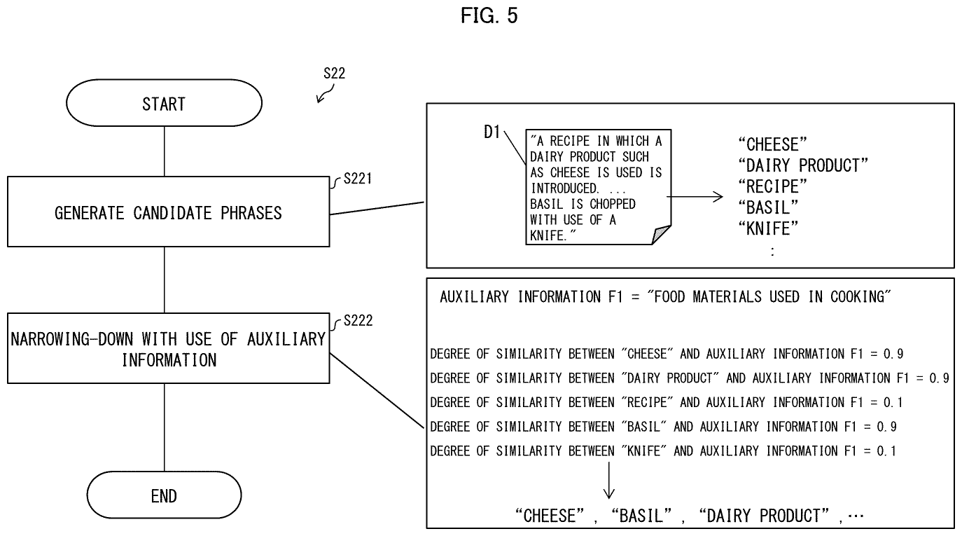

The details of the step S22 are described with reference to FIG. 5. FIG. 5 is a flowchart illustrating an example of a detailed flow of a process in the step S22. As illustrated in FIG. 5, the process in the step S22 includes steps S221 and S222.

(Step S221)

In the step S221, the generating section 22 generates two or more phrases which are candidates, with reference to the sentence group D1. In a process of generating such candidate phrases, a technique disclosed in, for example, Non-Patent Literature 1 can be used. Note, however, that a technique used in the process of generating the candidate phrases is not limited to this example.

### Detailed Example of Step S211

An example is described in which the sentence group D1 includes, for example, a sentence “a recipe in which a dairy product such as cheese is used is introduced . . . basil is chopped with use of a knife”, as illustrated in FIG. 5. In this case, the generating section 22 generates candidate phrases “cheese”, “dairy product”, “recipe”, “basil”, and “knife” from the sentence group D1.

(Step S222)

In the step S222, the generating section 22 extracts, from the two or more candidate phrases, a plurality of phrases of which degrees of similarity with the auxiliary information F1 each satisfy a given condition, and sets the plurality of phrases as a plurality of phrases to be included in the taxonomy T1. In other words, the generating section 22 narrows down the candidate phrases on the basis of a condition of being similar to the auxiliary information F1. An example of the given condition is a condition that a degree of similarity between a candidate phrase and the auxiliary information F1 is equal to or higher than a threshold. The degree of similarity can be calculated, for example, with use of distributed representations. Specifically, the degree of similarity may be a cosine similarity, an Euclidean distance, or the like between a distributed representation of the candidate phrase and a distributed representation of the auxiliary information F1. Note, however, that the given condition is not limited to the above example. Note also that a method of calculating the degree of similarity is not limited to the above example. Hereinafter, narrowing down the candidate phrases on the basis of the condition of being similar to the auxiliary information F1 is also referred to as “narrowing-down with use of the auxiliary information F1”.

### Detailed Example of Step S222

An example is described in which the auxiliary information F1 includes, for example, a natural language sentence “food materials used in cooking”, as illustrated in FIG. 5. In this case, the generating section 22 calculates 0.9 as a degree of similarity between “cheese”, among the candidate phrases, and the auxiliary information F1. Similarly, the generating section 22 calculates 0.9, 0.1, 0.9, and 0.1 as the degrees of similarity between “dairy product”, “recipe”, “basil” and “knife”, respectively, and the auxiliary information F1. In this manner, a phrase which conforms to the auxiliary information F1 “food materials used in cooking” has a high degree of similarity with the auxiliary information F1, as compared with a phrase which does not conform to the auxiliary information F1.

It is assumed, here, that the threshold is, for example, 0.7. In this case, the generating section 22 extracts, as the plurality of phrases to be included in the taxonomy T1, the phrases “cheese”, “dairy product”, and “basil” of which the degrees of similarity with the auxiliary information F1 are each equal to or higher than the threshold.

In this manner, by narrowing-down with use of the auxiliary information F1, the phrases “cheese”, “dairy product”, and “basil”, which are similar to the auxiliary information F1, are employed as the plurality of phrases to be included in the taxonomy T1, and “recipe” and “knife”, which are not similar to the auxiliary information F1, are not employed.

Note that FIG. 5 illustrates the example in which the candidate phrases are generated in the step S221 and then narrowing-down is carried out with use of the auxiliary information F1 in the step S222. However, the generating section 22 is not limited to this example. The generating section 22 may generate the phrases which are similar to the auxiliary information F1, by referring to the auxiliary information F1 in the process of generating the phrases from the sentence group D1.

<Details of Step S23>

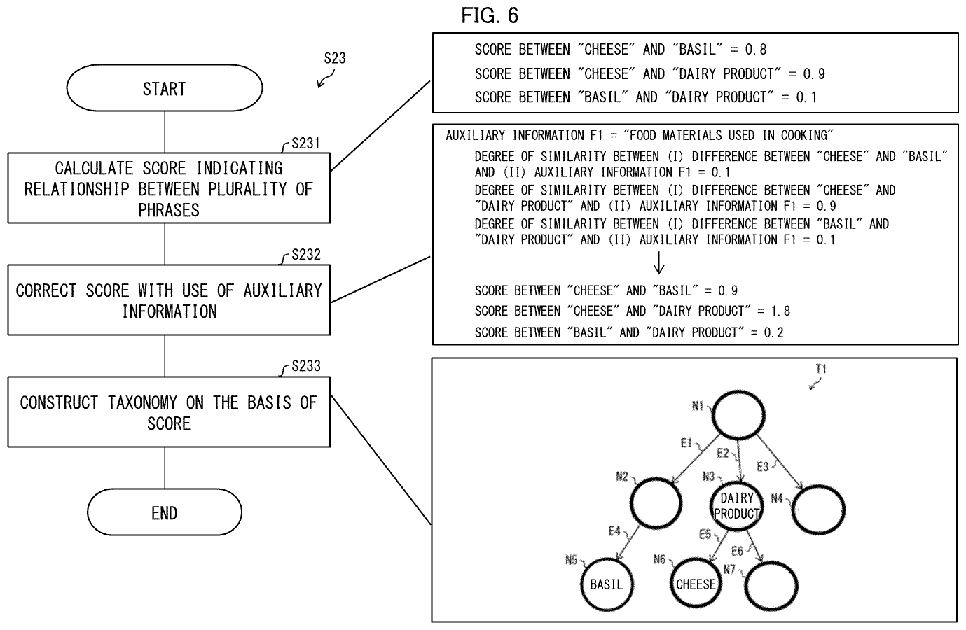

The details of the step S23 are described with reference to FIG. 6. FIG. 6 is a flowchart illustrating an example of a detailed flow of a process in the step S23. As illustrated in FIG. 6, the process in the step S23 includes steps S231 to S233.

(Step S231)

In the step S231, the constructing section 23 calculates a score indicating the relationship between the plurality of phrases to be included in the taxonomy T1. Note that the score is a degree of confidence in having the relationship, and is an example of “information indicating the relationship” recited in the claims. In a process of calculating the score indicating the relationship, a technique disclosed in, for example, Non-Patent Literature 1 can be used. Note, however, that a technique used in the process of calculating the information indicating the relationship is not limited to this example.

### Detailed Example of Step S231

For example, a detailed example of the step S231 in a case where the plurality of phrases “cheese”, “dairy product” and “basil” are generated in the step S22 is described. As an example, the constructing section 23 calculates 0.9 as a score indicating a relationship between the phrases “cheese” and “basil”. The score is considered to indicate a relationship in which the phrases “cheese” and “basil” are food materials having a good affinity with each other. Similarly, the constructing section 23 calculates 0.9 as a score indicating a relationship between the phrases “cheese” and “dairy product”. The score is considered to indicate a relationship in which “cheese” is included in “dairy product”. Furthermore, the constructing section 23 calculates 0.1 as a score indicating a relationship between the phrases “basil” and “dairy product”. The score indicates a possibility that these phrases do not have a relationship therebetween.

(Step S232)

In the step S232, the constructing section 23 corrects the score indicating the relationship between the plurality of phrases with use of the auxiliary information F1. For example, the constructing section 23 corrects the score with use of the following equation (1).

Sim(term1,term2)=Sim_original(term1,term2)+λ×Sim_d(term1,term2,description) (1)

In the equation (1), term1 and term2 represent two phrases, and description represents the auxiliary information F1. Sim( ) indicates a score after correction. Sim_original( ) indicates the score before the correction. Sim_d( ) represents a degree of similarity between (i) a difference between a distributed representation of term1 and a distributed representation of term2 and (ii) a distributed representation of description. Note that such a difference indicates a relationship between term1 and term2. Therefore, Sim_d( ) indicates a degree of similarity between (i) the relationship between term1 and term2 and (ii) the auxiliary information F1. A is a coefficient. Note, however, that a correcting process in which the auxiliary information F1 is used is not limited to this example.

### Detailed Example of Step S232

For example, the constructing section 23 calculates 0.1 as a degree of similarity between (i) a difference between a distributed representation of the phrase “cheese” and a distributed representation of the phrase “basil” and (ii) the distributed representation of the auxiliary information F1. This indicates that a degree of similarity between (i) the “relationship of food materials having a good affinity with each other” between the phrases “cheese” and “basil” and (ii) the auxiliary information F1 “food materials used in cooking” is low. Then, in accordance with the equation (1), the constructing section 23 adds the degree of similarity of 0.1 to the score of 0.8 between the phrases “cheese” and “basil”, and thereby corrects the score to 0.9. Note here that N=1 is applied.

Similarly, the constructing section 23 calculates 0.9 as a degree of similarity between (i) a difference between the distributed representation of the phrase “cheese” and a distributed representation of the phrase “dairy product” and (ii) the distributed representation of the auxiliary information F1. This indicates that a degree of similarity between (i) the relationship in which the phrase “cheese” is included in “dairy product” and (ii) the auxiliary information F1 “food materials used in cooking” is high. Then, in accordance with the equation (1), the constructing section 23 adds the degree of similarity of 0.9 to the score of 0.9 between the phrases “cheese” and “dairy product”, and thereby corrects the score to 1.8.

Similarly, the constructing section 23 calculates 0.1 as a degree of similarity between (i) a difference between the distributed representation of the phrase “basil” and the distributed representation of the phrase “dairy product” and (ii) the distributed representation of the auxiliary information F1. This indicates that a degree of similarity between (i) the relationship between the phrases “basil” and “dairy product” and (ii) the auxiliary information F1 “food materials used in cooking” is low. Then, in accordance with the equation (1), the constructing section 23 adds the degree of similarity of 0.1 to the score of 0.1 between the phrases “basil” and “dairy product”, and thereby corrects the score to 0.2.

In this manner, in a case where two phrases have therebetween the “relationship of food materials having a good affinity with each other”, which does not conform to the auxiliary information F1, a score indicating such a relationship is corrected to a relatively low value with use of the auxiliary information F1.

(Step S233)

In the step S233, the constructing section 23 constructs the taxonomy T1 on the basis of the corrected score. As an example, the constructing section 23 associates two phrases between which a score after correction is equal to or higher than a threshold.

### Detailed Example of Step S233

For example, the constructing section 23 associates the phrases “cheese” and “dairy product” between which the score after correction is equal to or higher than a threshold of 1.0, and thereby constructs the taxonomy T1 including these phrases. As illustrated in FIG. 6, the taxonomy T1 is represented by a directed graph which includes nodes N1 to N7 and edges E1 to E6. The nodes N1 to N7 respectively correspond to the plurality of phrases generated in the step S22. For example, the node N3 corresponds to the phrase “dairy product”. The node N5 corresponds to the phrase “basil”. The node N6 corresponds to the phrase “cheese”. Each of the edges E1 to E6 indicates that a relationship of a superordinate concept and a subordinate concept exists between two phrases connected to both ends of the each of the edges E1 to E6. In FIG. 6, each of the edges E1 to E6 is represented by an arrow. A node connected to a base of the arrow is a parent, and a node connected to an arrowhead of the arrow is a child. For example, the edge E5 indicates that the phrase “dairy product” corresponding to the node N2 which is connected to a base of the edge E5 is a parent (superordinate concept) and the phrase “cheese” corresponding to the node N5 which is connected to an arrowhead of the edge E5 is a child (subordinate concept).

Thus, the plurality of phrases “cheese”, “dairy product”, and “basil” are associated by the “relationship of a superordinate concept and a subordinate concept of food materials”, which is similar to the auxiliary information F1, and are not associated by the “relationship of food materials having a good affinity with each other”, which is not similar to the auxiliary information F1.

### Effects of the Present Example Embodiment

As described above, the information processing apparatus 2 in accordance with the present example embodiment generates a plurality of phrases which are similar to the sentence group D1, as a plurality of phrases to be included in the taxonomy T1. Thus, there is a high possibility that the plurality of phrases included in the constructed taxonomy T1 conform to the auxiliary information F1. The information processing apparatus 2 in accordance with the present example embodiment estimates a relationship which conforms to the auxiliary information F1, as a relationship between the plurality of phrases, and constructs the taxonomy T1 on the basis of an estimation result. Thus, there is a high possibility that the relationship included in the constructed taxonomy T1 conforms to the auxiliary information F1. The auxiliary information F1 is information relating to the taxonomy T1 to be constructed. Therefore, in the present example embodiment, it is possible to construct a desired taxonomy T1 more accurately.

### Another Aspect of the Present Example Embodiment

Note that, in the present example embodiment, the auxiliary information F1 may not be used in any one of the steps S22 and S23. For example, in the step S22, the generating section 22 may generate the phrases from the sentence group D1 without use of the auxiliary information F1. Specifically, the generating section 22 may omit the process in the step S222 out of the steps S221 and S222 illustrated in FIG. 5. In this case, the generating section 22 sets all of the candidate phrases determined in the step S221, as the plurality of phrases to be included in the taxonomy T1.

Further, for example, the constructing section 23 may construct the taxonomy T1 without use of the auxiliary information F1 in the step S23. Specifically, the constructing section 23 may omit the process in the step S232 out of the steps S231 to S233 illustrated in FIG. 6. Note, however, that the process in the step S232 can be omitted only in a case where the auxiliary information F1 is used in the step S22. In a case where the auxiliary information F1 is not used in the step S22, the constructing section 23 carries out the process in the step S232 without omitting the process in the step S232.

Thus, even in an aspect in which the auxiliary information F1 is used in one of the steps S22 and S23 and is not used in the other, it is possible to construct a desired taxonomy T1 more accurately, as compared with a case where the auxiliary information F1 is not used in both of the steps S22 and S23.

### Third Example Embodiment

The following description will discuss, in detail, a third example embodiment of the present invention with reference to drawings. Note that elements having the same functions as those of the elements described in the first and second example embodiments are denoted by the same reference signs, and descriptions thereof will not be repeated.

<Configuration of Information Processing Apparatus 3>

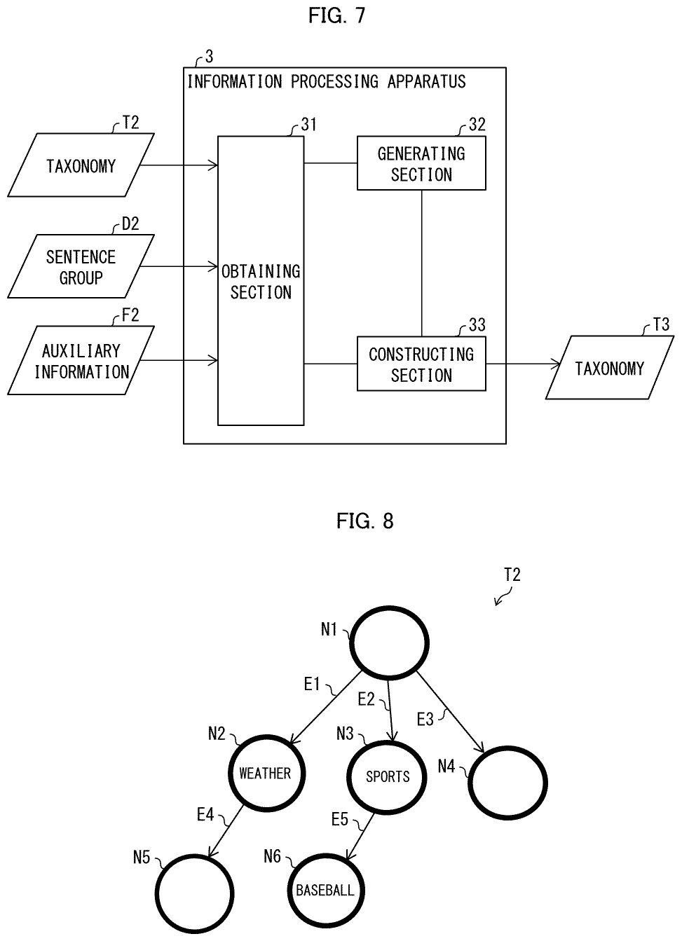

A configuration of an information processing apparatus 3 in accordance with the present example embodiment is described with reference to FIG. 7. FIG. 7 is a block diagram illustrating a functional configuration of the information processing apparatus 3. As illustrated in FIG. 7, the information processing apparatus 3 is an apparatus into which a taxonomy T2, a sentence group D2, and auxiliary information F2 are inputted and which outputs a taxonomy T3. The information processing apparatus 3 includes an obtaining section 31, a generating section 32, and a constructing section 33. The obtaining section 31 further obtains the taxonomy T2, in addition to being configured similarly to the obtaining section 11 in the first example embodiment. The generating section 32 generates a new phrase which differs from phrases that are included in the taxonomy T2, with reference to the sentence group D2. The constructing section 33 expands the taxonomy T2 and thereby constructs the taxonomy T3, by estimating a relationship between the new phrase and each of the phrases that are included in the taxonomy T2.

(Taxonomies T2 and T3)

A taxonomy T3 is a taxonomy outputted by the information processing apparatus 3, and is an example of a “taxonomy to be constructed” recited in the claims. A taxonomy T2 is a taxonomy which constitutes a part of the taxonomy T3, and is an example of a “partial taxonomy” recited in the claims. By expanding the taxonomy T2, the taxonomy T3 is constructed.

The taxonomy T2 includes phrases relating to a specific domain. Hereinafter, the expression “includes phrases relating to a specific domain” is also referred to as simply “relates to a specific domain”.

FIG. 8 is a drawing schematically illustrating an example of the taxonomy T2. In this example, the taxonomy T2 relates to a domain “news”. The taxonomy T2 is represented by a directed graph which includes nodes N1 to N7 and edges E1 to E6. The nodes N1 to N7 respectively correspond to a plurality of phrases relating to the domain “news”. For example, the node N2 corresponds to a phrase “weather”. The node N3 corresponds to a phrase “sports”. The node N6 corresponds to a phrase “baseball”. Note that the edges E1 to E6 are as described with reference to FIG. 6, and therefore, detailed descriptions thereof are not repeated.

(New Phrase)

A new phrase is a phrase which differs from each of the plurality of phrases included in the taxonomy T2, and is a phrase to be added to the taxonomy T2. In other words, the new phrase is a phrase which is not included in the taxonomy T2.

(Existing Phrase)

Hereinafter, each phrase included in the taxonomy T2 is referred to as “existing phrase” so as to be distinguished from a new phrase.

(Sentence Group D2)

A sentence group D2 is referred to when a phrase to be added to the taxonomy T2 is generated. The sentence group D2 is desirably a group of sentences relating to the same domain as that of existing phrases.

<Flow of Information Processing Method S3>

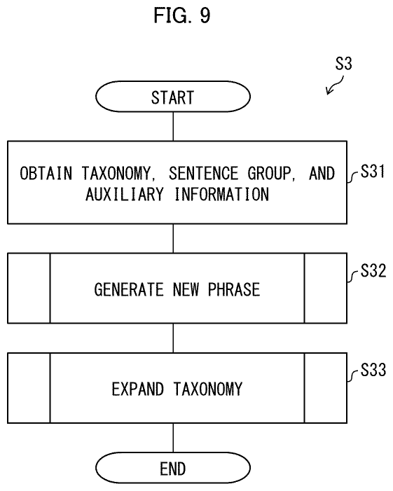

A flow of an information processing method S3 carried out by the information processing apparatus 3 configured as described above is described with reference to FIG. 9. FIG. 9 is a flowchart illustrating the flow of the information processing method S3. As illustrated in FIG. 9, the information processing method S3 includes steps S31 to S33.

(Step S31)

In the step S31, the obtaining section 31 obtains a taxonomy T2, a sentence group D2, and auxiliary information F2. For example, the obtaining section 31 may obtain a part or all of the taxonomy T2, the sentence group D2, and the auxiliary information F2 from a memory of the information processing apparatus 3, from another apparatus which is connected to the information processing apparatus 3 via a network, or via an input apparatus.

(Step S32)

In the step S32, the generating section 32 generates a new phrase which is similar to the auxiliary information F2, with reference to the sentence group D2. Details of this step are described later.

(Step S33)

In the step S33, the constructing section 33 estimates a relationship which conforms to the auxiliary information F2, as a relationship between (i) the new phrase which has been generated in the step S32 and (ii) each of existing phrases which are included in the taxonomy T2. The constructing section 33 expands the taxonomy T2 by associating the new phrase with one of the existing phrases on the basis of estimation results. Details of this step are described later.

<Details of Step S32>

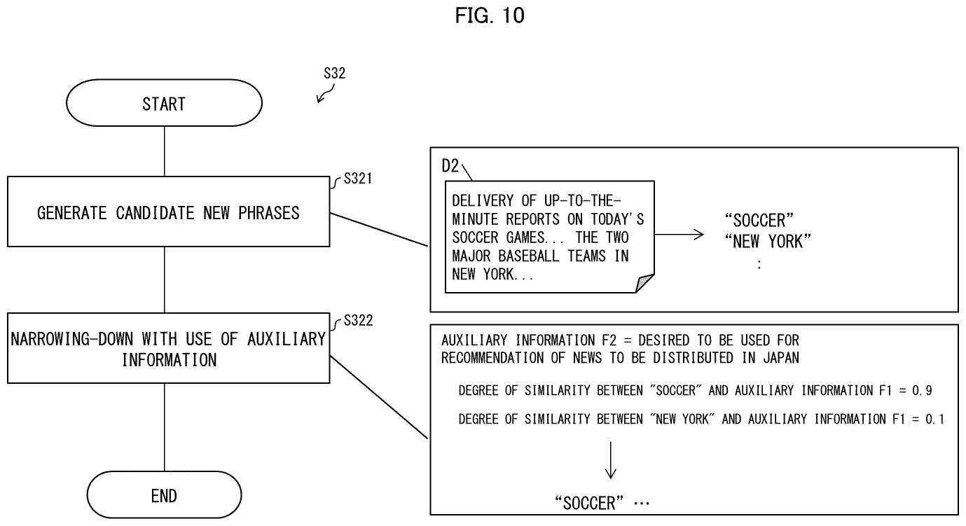

The details of the step S32 are described with reference to FIG. 10. FIG. 10 is a flowchart illustrating an example of a detailed flow of a process in the step S32. As illustrated in FIG. 10, the process in the step S32 includes steps S321 and S322.

(Step S321)

In the step S321, the generating section 32 generates candidate new phrases with reference to the sentence group D2. For example, the generating section 32 can use a language model in this step.

(Language Model)

A language model is a model that outputs a degree of confidence in a word string inputted thereinto. For example, a degree of confidence outputted in a case where a word string “his age is 100” is inputted into a language model is higher than a degree of confidence outputted in a case where a word string “his birthday is 100” is inputted into the language model. This is because this language model holds (i) a degree of confidence in a case where a relationship between “he” and “100” is “age” and (ii) a degree of confidence in a case where the relationship is “birthday” and the degree of confidence in the case where the relationship is “age” is higher than that in the case where the relationship is “birthday”. Further, with respect to a word string in which a word is masked, it is possible to predict, with use of the language model, a word which is suitable to a masked location. As an example of the language model, a language model generated by Reference Literature 1 or 2 below can be, for example, applied.
[Reference Literature 1] Jacob Devlin et al., “BERT: Pretraining of Deep Bidirectional Transformers for Language Understanding”, NAACL 2019.
[Reference Literature 2] Yinhan Liu et al., “RoBERTa: A Robustly Optimized BERT Pretraining Approach”, arXiv 2019.

For example, the generating section 32 may extract the candidate new phrases from the sentence group D2 with use of an extraction model generated with use of the language model. The extraction model includes the language model and a determiner into which an output from the language model is inputted. The extraction model is generated, by machine learning in which training data is used, so that, in a case where a sentence included in the sentence group D2 is inputted into the language model, the determiner determines and outputs new phrases. Note that the training data is data in which the existing phrases appearing in the sentence group D2 are regarded as ground truth. In this case, the generating section 32 sets, as the candidate new phrases, phrases that differ from the existing phrases, among the phrases extracted by inputting the sentence group D2 into the extraction model.

### Detailed Example of Step S321

As a detailed example, an example is described in which a sentence “delivery of up-to-the-minute reports on today's soccer games . . . . The two major baseball teams in New York . . . ” is included in the sentence group D2. In this case, the generating section 32 extracts phrases “soccer”, “New York”, and “baseball” by inputting the sentence group D2 into the extraction model. The generating section 32 sets the phrases “soccer” and “New York”, which are included in the phrases extracted by the extraction model and which differ from an existing phrase “baseball”, as candidate new phrases.

(Step S322)

In the step S322, the generating section 32 extracts, from the candidate new phrases, a phrase of which a degree of similarity with the auxiliary information F2 satisfies a given condition, and sets the phrase as the new phrase to be included in the taxonomy T2. In other words, the generating section 32 narrows down the candidate new phrases on the basis of a condition of being similar to the auxiliary information F2. An example of the given condition is a condition that a degree of similarity between a phrase and the auxiliary information F2 is equal to or higher than a threshold. The degree of similarity is as described above. Note, however, that the given condition is not limited to such an example.

### Detailed Example of Step S322

For example, an example is described in which a natural language sentence “desired to be used for recommendation of news to be distributed in Japan” is included in the auxiliary information F2. In this case, the generating section 32 calculates 0.9 as a degree of similarity between (i) a distributed representation of “soccer”, among the new phrases determined in the step S321, and (ii) a distributed representation of the auxiliary information F2. Similarly, the generating section 32 calculates 0.1 as a degree of similarity between (i) a distributed representation of “New York” and (ii) the distributed representation of the auxiliary information F2. In this manner, a phrase which conforms to the auxiliary information F2 has a high degree of similarity with the auxiliary information F2, as compared with a phrase which does not conform to the auxiliary information F2.

It is assumed, here, that the threshold is, for example, 0.7. In this case, the generating section 32 extracts, as the new phrase, the phrase “soccer” of which the degree of similarity with the auxiliary information F2 is equal to or higher than the threshold.

In this manner, by narrowing-down with use of the auxiliary information F2, the phrase “soccer”, which is similar to the auxiliary information F2, is employed as a new phrase to be included in the taxonomy T2, and “New York”, which is not similar to the auxiliary information F2, is not employed.

Note that FIG. 10 illustrates the example in which the candidate new phrases are generated in the step S321 and then narrowing-down is carried out with use of the auxiliary information F2 in the step S322. However, the generating section 32 is not limited to this example, and the generating section 32 may generate the new phrase which is similar to the auxiliary information F2, by referring to the auxiliary information F2 during a process of generating the new phrase from the sentence group D2.

<Details of Step S33>

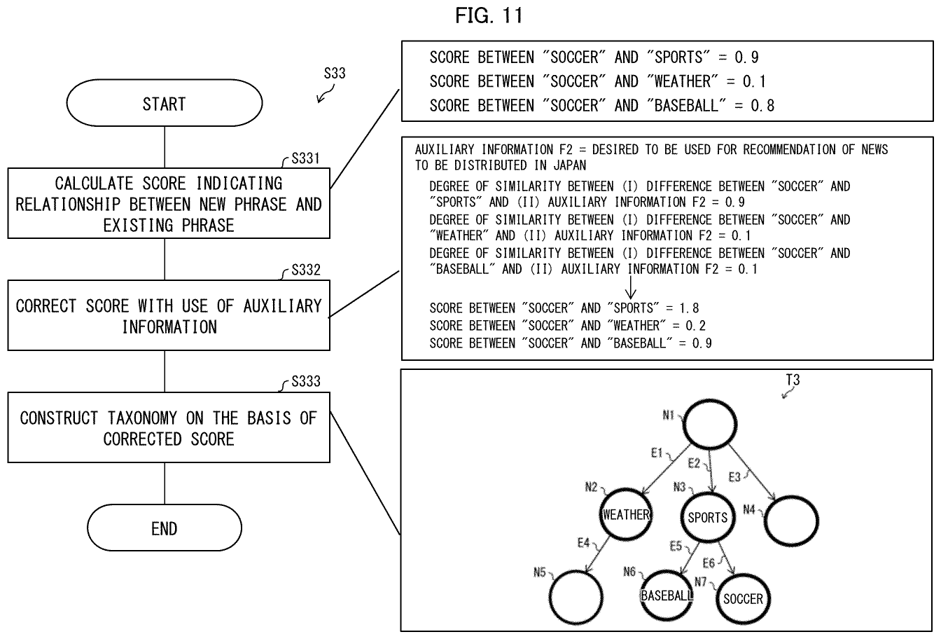

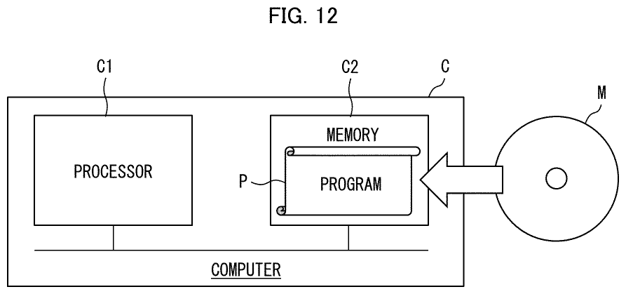

The details of the step S33 are described with reference to FIG. 11. FIG. 11 is a flowchart illustrating an example of a detailed flow of a process in the step S33. As illustrated in FIG. 11, the process in the step S33 includes steps S331 to S333.

(Step S331)

In the step S331, the constructing section 33 calculates a score indicating the relationship between the new phrase and each of the existing phrases. For example, the constructing section 33 can use a language model so as to calculate the score indicating the relationship between the new phrase and each of the existing phrases.

For example, the constructing section 33 may calculate, with use of the language model, a degree of confidence in a sentence including the new phrase and each of the existing phrases, and may use the calculated degree of confidence as the above-described score indicating the relationship.

### Detailed Example of Step S331

For example, a detailed example of the step S331 in a case where the new phrase “soccer” is generated in the step S32 is described. As an example, the constructing section 33 calculates 0.9 as a score between the new phrase “soccer” and the existing phrase “sports”. The score is considered to indicate a relationship in which “soccer” is included in “sports”. The constructing section 33 calculates 0.1 as a score between the new phrase “soccer” and the existing phrase “weather”. The score indicates a possibility that these phrases do not have a relationship therebetween. The constructing section 33 calculates 0.8 as a score between the new phrase “soccer” and the existing phrase “baseball”. The score is considered to indicate a “relationship in which both indicate kinds of sports”.

(Step S332)

In the step S332, the constructing section 33 corrects the score indicating the relationship between the new phrase and each of the existing phrases with use of the auxiliary information F2. For example, the constructing section 33 corrects the score by, in the above-described equation (1), regarding term1 as each of the existing phrases, regarding term2 as the new phrase, and regarding description as the auxiliary information F2. Note, however, that a correcting process in which the auxiliary information F2 is used is not limited to this example.

### Detailed Example of Step S332

For example, the constructing section 33 calculates 0.9 as a degree of similarity between (i) a difference between the distributed representation of the new phrase “soccer” and a distributed representation of the existing phrase “sports” and (ii) the distributed representation of the auxiliary information F2. This indicates that a degree of similarity between (i) the relationship in which the phrase “soccer” is included in “sports” and (ii) the auxiliary information F2 “desired to be used for recommendation of news to be distributed in Japan” is high. Then, in accordance with the equation (1), the constructing section 33 adds the degree of similarity of 0.9 to the score of 0.9 between the phrases “soccer” and “sports”, and thereby corrects the score to 1.8.

Similarly, the constructing section 33 calculates 0.1 as a degree of similarity between (i) a difference between the distributed representation of the new phrase “soccer” and a distributed representation of the existing phrase “weather” and (ii) the distributed representation of the auxiliary information F2. This indicates that a degree of similarity between (i) a relationship between the phrases “soccer” and “weather” and (ii) the auxiliary information F2 is low. Then, in accordance with the equation (1), the constructing section 33 adds the degree of similarity of 0.1 to the score of 0.1 between the phrases “soccer” and “weather”, and thereby corrects the score to 0.2.

Similarly, the constructing section 33 calculates 0.1 as a degree of similarity between (i) a difference between the distributed representation of the new phrase “soccer” and a distributed representation of the existing phrase “baseball” and (ii) the distributed representation of the auxiliary information F2. This indicates that, for example, a degree of similarity between (i) the relationship in which both of the phrases “soccer” and “baseball” indicate kinds of sports and (ii) the auxiliary information F2 “desired to be used for recommendation of news to be distributed in Japan” is low. Then, in accordance with the equation (1), the constructing section 33 adds the degree of similarity of 0.1 to the score of 0.8 between the phrases “soccer” and “baseball”, and thereby corrects the score to 0.9.

In this manner, in a case where the new phrase and any of the existing phrases has a “relationship in which both indicate kinds of sports”, which does not conform to the auxiliary information F2, a score indicating such a relationship is corrected to a relatively low value with use of the auxiliary information F2.

(Step S333)

In the step S333, the constructing section 33 expands the taxonomy T2 on the basis of the corrected score. As an example, the constructing section 33 associates the new phrase with one of the existing phrases of which the score with the new phrase after correction is equal to or higher than a threshold.

### Detailed Example of Step S333

For example, the score between the new phrase “soccer” and the existing phrase “sports” after correction is 1.8, which is equal to or higher than the threshold of 1.0. Therefore, as illustrated in FIG. 11, the constructing section 33 associates the node N7 corresponding to the new phrase “soccer” with the node N3 corresponding to the existing phrase “sports” by the edge E6. Thus, the taxonomy T3, which is obtained by expanding the taxonomy T2, is constructed.

In this manner, the new phrase “soccer” is associated with the existing phrase “sports” having a “relationship of a superordinate concept and a subordinate concept of news”, which conforms to the auxiliary information F2. The new phrase “soccer” is not associated with the existing phrase “baseball” having the relationship in which “both indicate kinds of sports” and which does not conform to the auxiliary information F2″.

### Effects of the Present Example Embodiment

As described above, the information processing apparatus 3 in accordance with the present example embodiment generates, as a new phrase to be added to the taxonomy T2, a phrase which is similar to the auxiliary information F2, with reference to the sentence group D2. Thus, there is a high possibility that the new phrase to be added to the taxonomy T2 conforms to the auxiliary information F2. The information processing apparatus 3 in accordance with the present example embodiment estimates, as a relationship between the new phrase and each of existing phrases, a relationship which conforms to the auxiliary information F2, and expands the taxonomy T2 on the basis of estimation results. Thus, there is a high possibility that the relationship included in the taxonomy T3 after expansion conforms to the auxiliary information F2. The auxiliary information F2 is information relating to the taxonomy T3 to be constructed. Therefore, in the present example embodiment, it is possible to construct a desired taxonomy T3 more accurately.

### First Aspect of the Present Example Embodiment

Note that, in the present example embodiment, the auxiliary information F2 may not be used in any one of the steps S32 and S33. For example, in the step S32, the generating section 32 may generate new phrases from the sentence group D2 without use of the auxiliary information F2. Specifically, the generating section 32 may omit the process in the step S322 out of the steps S321 and S322 illustrated in FIG. 10. In this case, the generating section 32 sets all of the candidate new phrases determined in the step S321, as the new phrases to be added to the taxonomy T2.

Further, for example, the constructing section 33 may expand the taxonomy T2 without use of the auxiliary information F2 in the step S33. Specifically, the constructing section 33 may omit the process in the step S332 out of the steps S331 to S333 illustrated in FIG. 11. Note, however, that the process in the step S332 can be omitted only in a case where the auxiliary information F2 is used in the step S32. In a case where the auxiliary information F2 is not used in the step S32, the constructing section 33 carries out the process in the step S332 without omitting the process in the step S332.

Thus, even in the first aspect in which the auxiliary information F2 is used in one of the steps S32 and S33 and is not used in the other, it is possible to construct a desired taxonomy T3 by expanding the taxonomy T2 more accurately, as compared with a case where the auxiliary information F2 is not used in both of the steps S32 and S33.

### Second Aspect of the Present Example Embodiment

In the present example embodiment, the example has been described in which, in the step S321, the candidate new phrases generated by the generating section 32 are phrases extracted from the sentence group D2. The generating section 32 is not limited to this example. The generating section 32 may generate a candidate new phrase by predicting, with reference to the sentence group D2, a phrase which is not necessarily included in the sentence group D2. In the process of predicting the candidate new phrase, it is possible to use, for example, a language model.

For example, the generating section 32 masks a location which is in a sentence included in the sentence group D2 and in which an existing phrase appears, and then predicts, with use of the language model, a phrase suitable to the masked location. In this case, the generating section 32 sets the predicted phrase as the candidate new phrase.

### Third Aspect of the Present Example Embodiment

In the present example embodiment, the example has been described in which, in the step S331, the score indicating the relationship between the new phrase and each of the existing phrases is calculated with use of the language model. Note that a method of calculating the score indicating the relationship with use of the language model is not limited to the example.

For example, the constructing section 33 may calculate the score indicating the relationship between the new phrase and each of the existing phrases, with use of a determination model generated with use of the language model. In this case, the determination model includes the language model and a classifier into which an output from the language model is inputted. The determination model is trained so that, in a case where a sentence including the new phrase and each of the existing phrases is inputted into the language model, the classifier outputs the score indicating the relationship. Training of the determination model is carried out with use of training data in which a relationship between two existing phrases indicated by the taxonomy T2 is regarded as ground truth.

[Variation 1]

In each of the second and third example embodiments, the example has been described in which the generating section 22, 32 narrows down the candidate phrases on the basis of the degrees of similarity with the whole auxiliary information F1, F2. The generating section 22, 32 may, but is not limited to, carry out narrowing-down on the basis of a degree of similarity between a candidate phrase and a part of the auxiliary information F1, F2 or a combination of degrees of similarity between the candidate phrase and different parts of the auxiliary information F1, F2. For example, the generating section 22 may carry out narrowing-down on the basis of a degree of similarity between the candidate phrase and a sentence which causes the degree of similarity to be the highest (or a phrase which causes the degree of similarity to be the highest), out of a plurality of sentences (or a plurality of phrases) included in the auxiliary information F1, F2. Further, for example, the generating section 22 may carry out narrowing-down on the basis of an average value of degrees of similarity between the candidate phrase and each of the plurality of sentences (or the plurality of phrases) included in the auxiliary information F1, F2.

[Variation 2]

In each of the second and third example embodiments, the example has been described in which the generating section 22, 32 narrows down the candidate phrases on the basis of the degrees of similarity with the distributed representation of the auxiliary information F1, F2. Note, however, that a method of narrowing down the candidate phrases with use of the auxiliary information F1, F2 is not limited to this example. For example, it is possible to use a language model in the process of narrowing down the candidate phrases with use of the auxiliary information F1, F2.

Specifically, the generating section 22, 32 may input, into the language model, sentences each including a candidate phrase and the auxiliary information F1, F2, and narrow down the candidate phrases on the basis of degrees of confidence outputted from the language model.

[Variation 3]

In each of the second and third example embodiments, the example has been described in which the constructing section 23, 33 corrects a score indicating a relationship between a plurality of phrases on the basis of a degree of similarity between (i) a difference in distributed representation which difference indicates the relationship and (ii) the auxiliary information F1, F2. Note, however, that a method of estimating a relationship which conforms to the auxiliary information F1, F2 is not limited to this example. For example, in the process of estimating the relationship which conforms to the auxiliary information F1, F2, it is possible to use a language model.

Specifically, the constructing section 23, 33 may input, into the language model, a sentence including two phrases and the auxiliary information F1, F2, and may calculate, on the basis of a degree of confidence outputted from the language model, a score indicating a relationship which conforms to the auxiliary information F1, F2.

[Variation 4]

In the second and third example embodiments, the example has been described in which the auxiliary information F1, F2 includes a natural language sentence. Note, however, that the auxiliary information F1, F2 may not include the natural language sentence. For example, the auxiliary information F1 may be a group of words such as “cuisine” and “food materials”. The auxiliary information F2 may be a group of words such as “news”, “Japan”, “distribution” and “recommendation”.

### Software Implementation Example

A part or all of the functions of each of the information processing apparatuses 1, 2, and 3 may be realized by hardware such as an integrated circuit (IC chip) or may be alternatively realized by software.

In the latter case, the information processing apparatuses 1, 2, and 3 are each realized by, for example, a computer that executes instructions of a program that is software realizing the functions. FIG. 12 illustrates an example of such a computer (hereinafter, referred to as “computer C”). The computer C includes at least one processor C1 and at least one memory C2. In the memory C2, a program P for causing the computer C to operate as each of the information processing apparatuses 1, 2, and 3 is recorded. In the computer C, the functions of each of the information processing apparatuses 1, 2, and 3 are realized by the processor C1 reading the program P from the memory C2 and executing the program P.

The processor C1 can be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 can be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can also be recorded in a non-transitory tangible recording medium M from which the computer C can read the program P. Such a recording medium M can be, for example, a tape, a disk, a card, a semiconductor memory, a programmable logic circuit, or the like. The computer C can acquire the program P via such a recording medium M. The program P can also be transmitted via a transmission medium. Such a transmission medium can be, for example, a communication network, a broadcast wave, or the like. The computer C can acquire the program P via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as follows. Note, however, that the present invention is not limited to the following example aspects.

(Supplementary Note 1)

An information processing apparatus including:
an obtaining means for obtaining a sentence group and auxiliary information which relates to a taxonomy to be constructed;
a generating means for generating a phrase with reference to the sentence group; and
a constructing means for constructing the taxonomy by estimating a relationship between a plurality of phrases including the phrase,
one or both of the generating means and the constructing means using the auxiliary information.

According to the above configuration, in a case where the auxiliary information is used by the generating means, there is a high possibility that the phrases included in the constructed taxonomy are desired phrases which conform to contents of the auxiliary information. In a case where the auxiliary information is used by the constructing means, there is a high possibility that the relationship between the plurality of phrases in the constructed taxonomy is a desired relationship which conforms to the contents of the auxiliary information. Therefore, it is possible to construct a desired taxonomy more accurately.

(Supplementary Note 2)

The information processing apparatus as described in Supplementary note 1, wherein the generating means generates, with reference to the sentence group, the phrase which is similar to the auxiliary information.

According to the above configuration, since the phrases included in the constructed taxonomy are similar to the auxiliary information, there is a high possibility that the phrases are desired phrases.

(Supplementary Note 3)

The information processing apparatus as described in Supplementary note 2, wherein the generating means generates candidate phrases with reference to the sentence group, and extracts, from the candidate phrases, the phrase of which a degree of similarity to the auxiliary information satisfies a given condition.

According to the above configuration, it is possible to reduce a possibility that the constructed taxonomy includes a phrase which is not desired.

(Supplementary Note 4)

The information processing apparatus as described in any one of Supplementary notes 1 through 3, wherein, as the relationship between the plurality of phrases, the constructing means estimates a relationship which conforms to the auxiliary information.

According to the above configuration, since the relationship included in the constructed taxonomy conforms to the auxiliary information, there is a high possibility that the relationship is a desired relationship.

(Supplementary Note 5)

The information processing apparatus as described in Supplementary note 4, wherein the constructing means estimates the relationship which conforms to the auxiliary information, by (i) calculating information indicating the relationship between the plurality of phrases and (ii) correcting, with use of the auxiliary information, the information calculated.

According to the above configuration, since the relationship included in the constructed taxonomy is a relationship corrected with use of the auxiliary information, there is a high possibility that the relationship is a desired relationship.

(Supplementary Note 6)

The information processing apparatus as described in any one of Supplementary notes 1 through 5, wherein the auxiliary information includes a natural language sentence. According to the above configuration, it is possible to use a natural language sentence which can be easily generated, as the auxiliary information used to generate a more accurate taxonomy.

(Supplementary Note 7)

The information processing apparatus as described in any one of Supplementary notes 1 through 5, wherein the auxiliary information includes a group of words.

According to the above configuration, it is possible to use a group of words which can be easily generated, as the auxiliary information used to generate a more accurate taxonomy.

(Supplementary Note 8)

The information processing apparatus as described in any one of Supplementary notes 1 through 7, wherein:
the obtaining means further obtains a partial taxonomy which constitutes a part of the taxonomy to be constructed;
the generating means generates a new phrase which differs from a phrase that is included in the partial taxonomy, with reference to the sentence group; and
the constructing means expands the partial taxonomy by estimating a relationship between the new phrase and the phrase that is included in the partial taxonomy.

According to the above configuration, it is possible to more accurately cause the taxonomy, which is constructed by expanding the partial taxonomy, to be a desired taxonomy which conforms to the contents of the auxiliary information.

(Supplementary Note 9)

An information processing method including:
obtaining a sentence group and auxiliary information which relates to a taxonomy to be constructed;
generating a phrase with reference to the sentence group; and
constructing the taxonomy by estimating a relationship between a plurality of phrases including the phrase,
in one or both of generating the phrase and constructing the taxonomy, the auxiliary information being used.

According to the above configuration, an effect similar to that brought about by Supplementary note 1 is brought about.

(Supplementary Note 10)

A program for causing a computer to function as an information processing apparatus, the program causing the computer to function as:
an obtaining means for obtaining a sentence group and auxiliary information which relates to a taxonomy to be constructed;
a generating means for generating a phrase with reference to the sentence group; and
a constructing means for constructing the taxonomy by estimating a relationship between a plurality of phrases including the phrase,
one or both of the generating means and the constructing means using the auxiliary information.

According to the above configuration, an effect similar to that brought about by Supplementary note 1 is brought about.

[Additional Remark 3]

The whole or part of the example embodiments disclosed above can also be expressed as follows.

An information processing apparatus including at least one processor, the at least one processor carrying out:
an obtaining process of obtaining a sentence group and auxiliary information which relates to a taxonomy to be constructed;
a generating process of generating a phrase with reference to the sentence group; and
a constructing process of constructing the taxonomy by estimating a relationship between a plurality of phrases including the phrase,
in one or both of the generating process and the constructing process, the auxiliary information being used.

Note that this information processing apparatus may further include a memory, and, in this memory, a program may be stored which is for causing the at least one processor to carry out the obtaining process, the generating process, and the constructing process. Alternatively, this program may be recorded in a computer-readable non-transitory tangible recording medium.

### REFERENCE SIGNS LIST

1, 2, 3 Information processing apparatus
11, 21, 31 Obtaining section
12, 22, 32 Generating section
13, 23, 33 Constructing section

What is claimed is:

1. An information processing apparatus comprising
at least one processor,
the at least one processor carrying out:
an obtaining process of obtaining a sentence group and auxiliary information which relates to a taxonomy to be constructed;
a generating process of generating a phrase with reference to the sentence group; and
a constructing process of constructing the taxonomy by estimating a relationship between a plurality of phrases including the phrase,
in one or both of the generating process and the constructing process, the at least one processor using the auxiliary information.

2. The information processing apparatus as set forth in claim 1, wherein in the generating process, the at least one processor generates, with reference to the sentence group, the phrase which is similar to the auxiliary information.

3. The information processing apparatus as set forth in claim 2, wherein in the generating process, the at least one processor generates candidate phrases with reference to the sentence group, and extracts, from the candidate phrases, the phrase of which a degree of similarity to the auxiliary information satisfies a given condition.

4. The information processing apparatus as set forth in claim 1, wherein in the constructing process, the at least one processor estimates, as the relationship between the plurality of phrases, a relationship which conforms to the auxiliary information.

5. The information processing apparatus as set forth in claim 4, wherein in the constructing process, the at least one processor estimates the relationship which conforms to the auxiliary information, by (i) calculating information indicating the relationship between the plurality of phrases and (ii) correcting, with use of the auxiliary information, the information calculated.

6. The information processing apparatus as set forth in claim 1, wherein the auxiliary information includes a natural language sentence.

7. The information processing apparatus as set forth in claim 1, wherein the auxiliary information includes a group of words.

8. The information processing apparatus as set forth in claim 1, wherein:
in the obtaining process, the at least one processor further obtains a partial taxonomy which constitutes a part of the taxonomy to be constructed;
in the generating process, the at least one processor generates a new phrase which differs from a phrase that is included in the partial taxonomy, with reference to the sentence group; and
in the constructing process, the at least one processor expands the partial taxonomy by estimating a relationship between the new phrase and the phrase that is included in the partial taxonomy.

9. An information processing method comprising:
obtaining a sentence group and auxiliary information which relates to a taxonomy to be constructed;
generating a phrase with reference to the sentence group; and
constructing the taxonomy by estimating a relationship between a plurality of phrases including the phrase,
obtaining the sentence group and the auxiliary information, generating the phrase, and constructing the taxonomy being carried out by at least one processor,
in one or both of generating the phrase and constructing the taxonomy, the at least one processor using the auxiliary information.

10. A non-transitory recording medium in which a program is recorded, the program causing a computer to carry out:
an obtaining process of obtaining a sentence group and auxiliary information which relates to a taxonomy to be constructed;
a generating process of generating a phrase with reference to the sentence group; and
a constructing process of constructing the taxonomy by estimating a relationship between a plurality of phrases including the phrase,
in one or both of the generating process and the constructing process, the computer using the auxiliary information.
